(19) United States
(12) Patent Application Publication
(10) Pub. No.: US 2007/0215751 A1
(43) Pub. Date: Sep. 20, 2007

(54) Asymmetrical VTOL UAV

(76) Inventors: Brent A. Robbins, Saint Louis, MO (US); Patrick F. Cassidy, St. Peters, MO (US)

Correspondence Address: MACPHERSON KWOK CHEN & HEID, LLP, 2033 GATEWAY PLACE, SUITE 400, SAN JOSE, CA, 95110, US

(21) Appl. No.: 11/384,582

(22) Filed: Mar. 20, 2006

(51) Int. Cl. B64D 27/00

(52) U.S. Cl. 244/55

(57) ABSTRACT

A vertical takeoff and landing (“VTOL”) unmanned aerial vehicle (“UAV”) incorporates a pair of substantially identical thrust-vectoring engines, e.g., turbofans, which are respectively mounted on opposite sides of the aircraft at substantially equal lateral and vertical distances above or below, and at substantially equal longitudinal distances forward and aft of, the center of gravity of the aircraft. The thrust vectoring of the engines can be either two-dimensional or three-dimensional, and can be effected by rotatable vanes, flaps, nozzles or combination thereof, on the engines. By locating the engines equidistantly from the center of gravity of the aircraft and re-spectively forward and aft of its pitch axis, the aircraft is provided with VTOL capability, including hovering, and the operation of its conventional attitude control mechanisms are substantially enhanced at both very low and very high speeds. The vehicle is particularly well suited to missions in hostile urban environments, such as cities.

### TECHNICAL FIELD

This invention pertains to aircraft, in general, and in particular, to an unmanned aerial vehicle (“UAV”) having a pair of engines placed forward and aft of its center of gravity to provide it with vertical takeoff and landing (“VTOL”) capability, including hovering, as well as high agility and maneuverability at both very low and very high speeds.

### BACKGROUND

An unmanned aircraft (“UA”), or unmanned aerial vehicle (“UAV”), is a powered, heavier-than-air, aerial vehicle that does not carry a human operator, or pilot, and which uses aerodynamic forces to provide vehicle lift, can fly autonomously or be piloted remotely, can be expendable or reusable, and can carry a lethal or a non-lethal payload. Thus, ballistic or semi-ballistic vehicles, cruise missiles, and artillery projectiles are not considered UAVs.

In recent conflicts around the world, including the global war on terrorism, UAVs have proven to be very effective, both as a surveillance and intelligence-gathering tool, and as a weapons-delivery platform. Because they are unmanned, and cost substantially less to produce and operate than conventional manned aircraft, UAVs are capable of providing effective surveillance of an enemy, and/or of effecting a devastating attack upon him, while denying him either a high-value target or a potential captive in exchange.

An important UAV task or mission that has emerged recently in the war on terrorism is the need for an aerial vehicle that can enter an urban target environment, such as a city with tall buildings, at a relatively high speed, hover and maneuver (e.g., weave between the buildings) within that environment at a relatively low speed while surveilling a very specific target area and/or deploying a weapon payload against the target in such a way as to minimize collateral damage, and then exit the area at a relatively high speed. This necessitates an aerial vehicle that can carry a relatively heavy payload (i.e., ordinance, cameras, sensors or the like), is extremely maneuverable (i.e., can effect quick changes in altitude and very small turn-radii) at slow speeds, and has a high speed (i.e., high subsonic) flight capability.

The prior art technique for meeting this need has been either to deploy a large, fast vehicle lacking low speed maneuverability, but carrying a payload capable of destroying a large target area, or alternatively, to carry a much smaller weapon/payload package aboard a relatively smaller vehicle that, although slower than the former, is capable of achieving the requisite low-speed maneuverability. Thus, the disadvantages of the prior art techniques are, on the one hand, that larger vehicles which are capable both of carrying larger payloads and meeting the vehicle speed requirements are too large to fly between buildings in an urban environment and lack the maneuverability at slower speeds required to be effective in that environment, and on the other, that smaller vehicles having low speed agility also have limited speed and payload carrying capabilities.

Accordingly, what is needed is a UAV having VTOL capabilities, including hovering capabilities, that is capable of carrying a relatively large payload, and which is also highly maneuverable at both very low and very high speeds.

### BRIEF SUMMARY

In accordance with the exemplary embodiments thereof described herein, the present invention provides a VTOL aircraft, e.g., a UAV, that has a relatively large payload-carrying capability, and yet which is highly maneuverable at both very low and very high speeds.

In one possible exemplary embodiment, the aircraft comprises a conventional airframe having an elongated fuselage with an empennage and a pair of wings. A pair of substantially identical thrust-vectoring engines is respectively mounted on opposite sides of the aircraft such that their respective thrust outlets are located at substantially equal lateral and vertical distances from, and at substantially equal longitudinal distances forward and aft of, the center of gravity (“CG”) of the aircraft. That is, the respective thrust outlets of the engines are located equidistantly below the center of gravity of the aircraft, but one is located forward, and the other aft, of the aircraft's CG.

The thrust vectoring of the engines can comprise either two-dimensional, or preferably, three-dimensional thrust vectoring, and can be effected by means of, e.g., rotatable vanes, flaps or nozzles, or combinations thereof, disposed at the thrust outlets of the engines. In an efficient subsonic embodiment, the engines can comprise turbofan engines.

A vertical takeoff of the aircraft is effected by deflecting or redirecting the exhaust of both engines substantially downward, resulting in a substantially upward thrust of the engines, increasing the thrust of the engines until the combined thrust exceeds the weight of the aircraft and it rises to a selected altitude, and then rotating the direction of thrust of the engines forward until the aircraft accelerates to a speed at which a lifting surface of the UAV, e.g., its wings, produce lift. A vertical landing of the aircraft is effected in substantially the reverse of the foregoing procedure.

During high speed flight, and in addition to the conventional mechanisms normally used to control the aircraft's lift and attitude relative to the conventional roll, pitch and yaw axes extending through its CG, i.e., its wings, elevators, ailerons, and rudders, the pitch of the aircraft can also be effectively controlled by rotating the respective direction of thrust of the engines vertically, i.e., upward or downward and laterally in opposite directions such that the aircraft pitches down or up, respectively, in a selected direction about the pitch axis of the aircraft. Additionally, by rotating the respective directions of thrust of the engines vertically and in opposite directions relative to each other, the aircraft is made to roll in a selected direction about a roll axis of the aircraft. Finally, by rotating the direction of thrust of respective ones of the engines in the either the same or in opposite lateral directions, the aircraft can be made to translate horizontally or yaw in a selected direction about the yaw axis of the aircraft.

During low speed operation of the aircraft, in which the above conventional lift and attitude control mechanisms of the aircraft are substantially ineffective, hovering is achieved by directing the thrusts of the engines substantially upward, increasing the thrust of the engines until the thrust exceeds the weight of the UAV and it rises to a selected altitude, and then decreasing the thrust of the engines until the combined thrust of the engines is equal to the weight of the UAV and it hovers at the selected altitude. Low speed maneuvering of the aircraft is effected by increasing the thrust of the engines until the thrust exceeds the weight of the UAV, and then rotating the respective directions of thrust of the engines in the same or in opposite horizontal directions until an upward component of the thrust is substantially equal to the weight of the aircraft, and the aircraft either translates horizontally in a selected direction, and/or yaws in a selected direction about the yaw axis of the aircraft, in the manner described above.

A better understanding of the above and many other features and advantages of the VTOL UAV of the present invention may be obtained from a consideration of the exemplary embodiments thereof described in detail below, particularly if such consideration is made in conjunction with the appended drawings, wherein like reference numerals are used to identify like elements illustrated in one or more of the figures thereof.

### BRIEF DESCRIPTION OF THE DRAWINGS

FIG. 1 is an upper left rear perspective view of an exemplary embodiment of a VTOL UAV in accordance with the present invention;

FIG. 2 is a top plan view thereof;

FIG. 3 is a left side elevation view thereof;

FIG. 4 is a bottom plan view thereof;

FIG. 5 is a front end elevation view thereof;

FIG. 6 is thrust and weight vector diagram of the exemplary VTOL UAV, as seen looking into the left side thereof; and,

FIG. 7 is a thrust, weight and lift vector diagram similar to FIG. 6.

### DETAILED DESCRIPTION

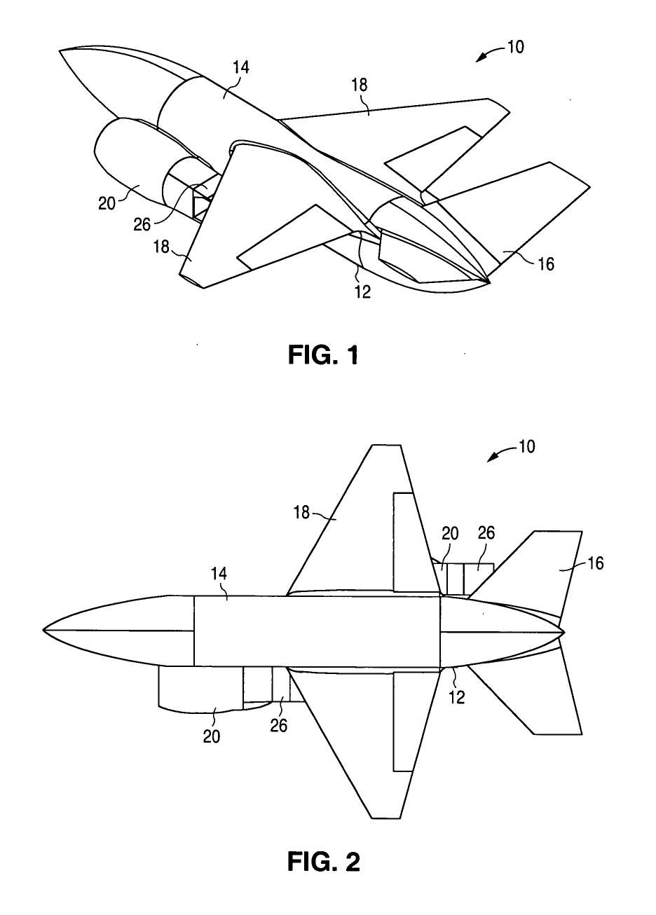

FIGS. 1 and 2 are upper left rear perspective and top plan views, respectively, of an exemplary embodiment of a vertical takeoff and landing (“VTOL”) aircraft 10, e.g., an unmanned aircraft (“UA”) or unmanned aerial vehicle (“UAV”), in accordance with the present invention. As may be seen by reference to the figures, the aircraft comprises a relatively conventional airframe that includes an elongated fuselage 14 having an empennage 16 and a pair of wings 18. In the particular embodiment illustrated in the figures, the empennage comprises an upright V-tail configuration, but in other possible embodiments, the empennage can comprise an inverted V-tail configuration, or alternatively, a conventional T-tail configuration.

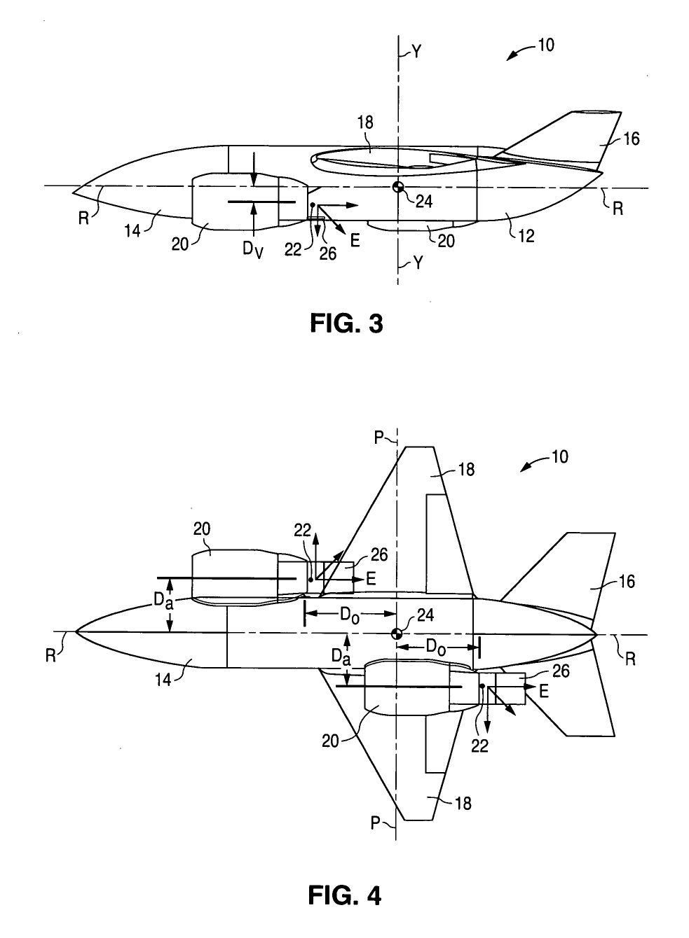

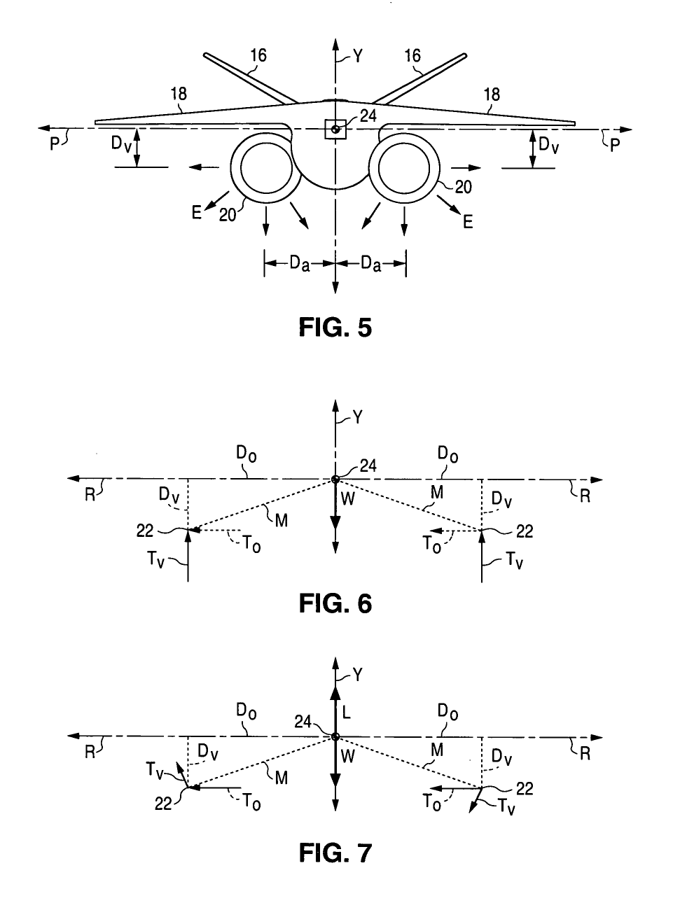

Of importance, the aircraft 10 is provided with a pair of substantially identical thrust-vectoring engines 20, which are respectively mounted on opposite sides of the fuselage 14 of the aircraft such that their respective thrust outlets 22 are located at substantially equal lateral and vertical distances Dₐ and Dᵥ from the aircraft's center of gravity (“CG”) 24, and at substantially equal longitudinal distances D₀ forward and aft of the CG, as illustrated in the left side elevation, bottom plan, and front end elevation views of FIGS. 3-5, respectively. That is, like most conventional aircraft with two engines, the respective thrust outlets 22 of the engine are located equidistantly above or below the CG of the aircraft, as measured along the respective roll, pitch and yaw axes R, P, and Y of the aircraft that extend through its CG, but unlike conventional aircraft, the thrust outlets of the engines are located on opposite sides, i.e., forward and aft, of the pitch axis P, as illustrated in FIG. 4, rather than longitudinally in line with each other. As discussed in more detail below, this unconventional location of the engine outlets provides the aircraft with both VTOL capability and high maneuverability at both very low and very high speeds.

In an exemplary subsonic embodiment of the aircraft 10, i.e., one capable of speeds of up to about mach 0.85, the engines 20 preferably comprise thrust-vectoring turbofan engines, in which the thrust-vectoring function is achieved by rotatable nozzles, flaps or vanes 26, or combinations thereof, located at the engine thrust outlets 22. These mechanisms can effectively deflect, i.e., direct, the exhaust vector E, and hence, the equal in magnitude and oppositely directed thrust vector T, of the engines as much as 90 degrees relative to the thrust vector of a conventional “ax-isymmetric” engine nozzle, as indicated by the engine exhaust arrows E of FIGS. 3-5. In a conventional “two-dimensional” thrust-vectoring arrangement, this deflection is limited to ±90 degrees up-and-down deflections, whereas, in a “three-dimensional” arrangement, the deflection includes both ±90 degrees up-and-down, and left-and-right deflections, such that the respective thrust vectors T of the engines can be either independently or concurrently directed along an axis located anywhere within a substantially hemispherical region behind the respective engines. Although other types of engines, e.g., turbojet engines, can be also be employed in the aircraft, turbojets are contraindicated in a subsonic VTOL embodiment because turbojet engines are less fuel efficient than turbofans, resulting in additional fuel-weight penalty, and because after-burning, necessary for supersonic flight, is difficult and expensive to implement in a three-dimensional thrust-vectoring nozzle or vane arrangement. Similarly, while other types of thrust-vectoring mechanisms, e.g., so-called “fluidic vectoring,” can be utilized in the aircraft in place of the thrust-vectoring nozzles, flaps and/or vane arrangements, these are currently not capable of achieving the same range of thrust deflection as the former.

FIG. 6 is a thrust and weight vector diagram of the exemplary VTOL UAV 10, as seen looking into the left side thereof, which illustrates how disposing the thrust outlets 22 of the engines 20 fore and aft of the CG 24 of the aircraft provides it with both VTOL capability and high maneuverability at both very low and very high speeds. As illustrated in the figure, each of the engines produces a thrust vector T at its respective thrust outlet 22, which act at the end of respective moment arms M, derived from the mutually perpendicular longitudinal, lateral and vertical moment arms of respective equal lengths D₀, Dₐ and Dᵥ, acting through the CG. If the magnitudes and directions of the respective thrust vectors of the engines are equal, the sum of the moments generated by the vectors about the CG of the aircraft will be zero, i.e., the moments will exactly counterbalance each other, such that the aircraft will be accelerated with pure translational movement in the same direction as that of the respective thrust vector components T₀, Tₐ and Tᵥ.

Thus, for example, to effect a vertical takeoff maneuver, the respective thrust vectors T of both engines 20 are directed substantially upward by the thrust deflectors 26 such that the respective longitudinal and lateral components T₀ and Tₐ of the thrust vectors are substantially zero and their respective vertical components Tᵥ are substantially equal to T. The thrust is then increased until the combined thrust of the engines exceeds the weight W of the UAV acting through the aircraft's CG 24, and the aircraft 10 rises vertically, without any rolling, pitching or yawing, to a selected altitude. The direction of the thrust vectors T of both engines are then rotated, or directed, forward such that the vertical components of the respective thrust vectors Tᵥ approach zero and the respective longitudinal components T₀ approach T. The UAV then begins to accelerate to a forward speed at which a surface of the vehicle, e.g., its wings 18, produces a lifting force L, which acts through the aircraft's CG in the opposite direction to its weight W, as illustrated in FIG. 7. When the lift of the aircraft's wings is equal to the weight of the aircraft, and is therefore sufficient to sustain the vehicle in conventional flight, the respective thrust vectors T of the engines are then directed substantially forward, such that their respective vertical components Tᵥ are substantially zero and their respective longitudinal components T₀ are each substantially equal to T, whereupon the aircraft accelerates forward to a higher speed at which the combined thrust of the engines is counterbalanced by the aerodynamic drag acting on the aircraft. The aircraft effects a vertical landing by effecting the foregoing procedure in substantially the reverse order.

As those of skill in the art will appreciate, in addition to the conventional mechanisms that are normally utilized at high speeds to control an aircraft's attitude relative to its respective roll, pitch and yaw axes R, P and Y, i.e., its ailerons, elevators and rudders, the attitude, and hence, the maneuverability, of the exemplary aircraft 10 can also be effectively controlled and enhanced during high speed flight by the thrust-vectoring engine 20 arrangement of the present invention. Thus, as illustrated in FIG. 7, by rotating the direction of the respective thrust vectors T of the forward and rearward engines such that the vertical and longitudinal components Tᵥ and T₀ of the thrust vectors are respectively directed upward and forward, and downward and forward, respectively, the combined, non-zero moment of the respective vertical thrust components about the aircraft's CG will cause the aircraft to pitch down or up, respectively, about its pitch axis P, i.e., in the direction of the applied moment. In this regard, it may be noted that, because of the disposition of the thrust-vectoring engines, the exact rotations of pitch, roll and yaw are all coupled together. In other words, rolling the aircraft will also incorporate a bit of yaw and a bit of pitch.

Similarly, by rotating the direction of the respective thrust vectors T of the engines 20 such that the respective lateral thrust components Tₐ are zero and the vertical thrust components Tᵥ are respectively directed upward or downward and in opposite directions to each other, the combined, non-zero moment of the respective vertical thrust components about the aircraft's CG 24 will cause the aircraft to roll about its roll axis R in the direction of the applied moment.

Likewise, by rotating the direction of the respective thrust vectors T of the engines such that the respective vertical thrust components Tᵥ are zero, and the lateral thrust components Tₐ are directed in opposite directions to each other, the combined, non-zero moment of the respective horizontal thrust components about the aircraft's CG 24 will cause the aircraft to yaw about its yaw axis Y, in the direction of the applied moment.

As those of skill in the art will further appreciate, the conventional mechanisms normally utilized at high speeds to control the aircraft's attitude relative to its respective roll, pitch and yaw axes R, P and Y are substantially impaired or altogether non-functional at low speeds, including a still, or hovering situation. However, the thrust-vectoring engine 20 arrangement of the present invention also enables a precise control of the attitude of the exemplary aircraft 10 under such conditions. Thus, the aircraft is caused to hover by directing the respective thrust vectors T of the engines substantially upward, increasing the thrust of the engines until the combined thrust exceeds the weight W of the aircraft and it rises vertically to a selected altitude, as in the above vertical takeoff maneuver. The thrust of the engines is then decreased until the combined thrust is equal to the aircraft's weight, whereupon the aircraft hovers at the selected altitude. Low speed control of the aircraft's attitude, or maneuvering, is then effected in a manner similar to that described above in connection with its high speed maneuvering, except that substantially all of the lift L of the aircraft is provided by the thrust of the engines, rather than its wings 18.

For example, low speed horizontal translation of the aircraft 10 is effected by increasing the thrust of the engines 20 until the thrust exceeds the weight W of the vehicle, rotating the direction of the respective thrust vectors T of the engines in the same lateral directions until the combined upward components Tᵥ of the thrust vectors are substantially equal to the weight of the aircraft, the sum of the moments of the respective horizontal components Tₐ and T₀ of the respective thrust vectors about the aircraft's CG 24 is zero, and the aircraft translates horizontally in the same direction as the combined horizontal thrust vectors Tₐ and/or T₀, as illustrated in FIG. 6. It should be understood that, although FIG. 6 illustrates the thrust vector arrangement for translating the vehicle in a forward, or longitudinal, direction, the vehicle can translate in any horizontal direction by appropriate thrust-vectoring of the engines.

Low speed yawing of the aircraft 10 about its yaw axis Y is effected in a manner similar to that described above, except that the thrust vectors of the engines are directed in opposite lateral directions such that the combined, non-zero moment of the respective lateral thrust components Tₐ about the aircraft's CG 24 causes it to yaw about the yaw axis in the direction of the applied moment.

By now, those of skill in this art will appreciate that many modifications, substitutions and variations can be made in and to the materials, apparatus, configurations and methods of the VTOL UAV of the present invention without departing from its spirit and scope. In light of this, the scope of the present invention should not be limited to that of the particular embodiments illustrated and described herein, as they are only exemplary in nature, but instead, should be fully commensurate with that of the claims appended hereafter and their functional equivalents.

What is claimed is:

1. An aircraft, comprising a pair of substantially identical engines respectively mounted on opposite sides of the aircraft such that respective thrust outlets of the engines are located at substantially equal lateral and vertical distances from, and at substantially equal longitudinal distances forward and aft of, the center of gravity of the aircraft.

2. The aircraft of claim 1, wherein the engines comprise turbojet or turbofan engines.

3. The aircraft of claim 1, wherein the engines comprise thrust vectoring engines.

4. The aircraft of claim 3, wherein the thrust vectoring comprises two-dimensional or three-dimensional thrust vectoring.

5. The aircraft of claim 3, wherein the thrust vectoring is effected by means of rotatable vanes, flaps, nozzles or a combination thereof.

6. The aircraft of claim 3, wherein the aircraft comprises a VTOL aircraft.

7. The aircraft of claim 1, wherein the aircraft comprises a UAV aircraft.

8. A method for providing an aircraft with VTOL capabilities and high maneuverability at both very low and very high speeds, the method comprising respectively mounting a pair of substantially identical thrust-vectoring engines on opposite sides of the aircraft such that respective thrust outlets of the engines are located at substantially equal lateral and vertical distances from, and at substantially equal longitudinal distances forward and aft of, the center of gravity of the aircraft.

9. The method of claim 8, wherein the thrust vectoring comprises two-dimensional or three dimensional thrust vectoring.

10. The method of claim 8, wherein the engines comprise turbojet or turbofan engines.

11. The aircraft of claim 8, wherein the thrust vectoring is effected by means of rotatable vanes, flaps, nozzles or a combination thereof.

12. The aircraft of claim 8, wherein the aircraft comprises a UAV.

13. An aircraft provided with VTOL capabilities and high maneuverability at both very low and very high speeds in accordance with the method of claim 8.

14. A VTOL aircraft, comprising a pair of substantially identical thrust-vectoring engines respectively mounted on opposite sides of the aircraft such that respective thrust outlets of the engines are located at substantially equal lateral and vertical distances from, and at substantially equal longitudinal distances forward and aft of, the center of gravity of the aircraft.

15. The VTOL aircraft of claim 14, wherein the thrust vectoring comprises two-dimensional or three-dimensional thrust vectoring.

16. The VTOL aircraft of claim 14, wherein the engines comprise turbojet or turbofan engines.

17. The VTOL aircraft of claim 14, wherein the aircraft comprises a UAV.

18. A method of operating the VTOL UAV of claim 14, the method comprising:
directing the respective direction of thrust of the engines substantially upward;
increasing the respective thrusts of the engines until the combined thrust of the engines exceeds the weight of the UAV and the UAV rises to a selected altitude without pitching, rolling or yawing; and,
rotating the respective direction of thrust of both engines substantially forward such that the UAV accelerates to a speed at which a surface of the UAV produces lift.

19. The method of claim 18, further comprising rotating the respective directions of thrust of the engines in opposite vertical and lateral directions such that the aircraft pitches in a selected direction about a pitch axis of the aircraft.

20. The method of claim 18, further comprising rotating the respective direction of thrust of the engines in opposite vertical directions such that the aircraft rolls in a selected direction about a roll axis of the aircraft.

21. The method of claim 18, further comprising rotating the respective direction of thrust of the engines in opposite lateral directions such that the aircraft yaws in a selected direction about a yaw axis of the aircraft.

22. A method of operating the VTOL UAV of claim 14, the method comprising:
directing the respective thrusts of the engines substantially upward;
increasing the respective thrusts of the engines until the combined thrust of the engines exceeds the weight of the UAV and the UAV rises to a selected altitude without rolling, pitching or yawing; and,
decreasing the respective thrusts of the engines until the combined thrust of the engines is equal to the weight of the UAV and the UAV hovers at the selected altitude.

23. The method of claim 22, further comprising:
increasing the respective thrusts of the engines until the thrust exceeds the weight of the UAV; and,
rotating the respective direction of thrust of the engines in the same horizontal direction until an upward component of the thrusts is substantially equal to the weight of the aircraft, and the aircraft translates horizontally in a selected direction.

24. The method of claim 22, further comprising:
increasing the respective thrusts of the engines until the thrust exceeds the weight of the UAV; and,
rotating the respective direction of thrust of the engines in opposite lateral directions until an upward component of the thrust is substantially equal to the weight of the aircraft, and the aircraft yaws in a selected direction about a yaw axis of the aircraft.
